(19) United States
(12) Patent Application Publication
(10) Pub. No.: US 2024/0428505 A1
(43) Pub. Date: Dec. 26, 2024

(54) User Configurable and Editable Real time CGI Image Rendering

(71) Applicant: Katana Spooka Zoo, Gdansk (PL)

(72) Inventors: Marcin Borowiak, Gdynia (PL); Damian Matthew Fulmer, Royal Oak, MI (US); Wes Antoni Filipek, Tustin, CA (US)

(21) Appl. No.: 18/527,660

(22) Filed: Dec. 4, 2023

Related U.S. Application Data
(60) Provisional application No. 63/522,678, filed on Jun. 22, 2023.

(51) Int. Cl. G06T 15/20; G06T 5/50; G06T 19/20

(52) U.S. Cl. CPC G06T 15/20; G06T 5/50; G06T 19/20; G06T 2207/20221

(57) ABSTRACT

A CGI asset generation system with a web based user interface which receives selections and commands from a user to select a background an object, which commands are sent to a server, the server then uses a CGI program to generate an image file from those commands and displays with the perspective information of the background being used to modify how the object is displayed in the CGI asset by e.g. shading, lighting, shadow of the object and of the background as appropriate.

### FIELD OF THE INVENTION

The following relates to a Computer Generated Imagery (CGI) system that allows for real time or near real time editing and creation and revision.

### BACKGROUND OF THE INVENTION

Computer Generated Imagery (CGI) is used in many instances from movies and TV to advertising, both images and videos. However, the process of creating CGI content is complex, requiring specialized software and training to operate that software.

As a result, the process of creating CGI content for a particular purpose can be lengthy and complicated as the persons creating the content and manipulating the software are often not the decision makers who approve the content or who have a particular vision for the content. The result is a long trial and error process with multiple back and forth revisions and re-makes, all of which take significant time and effort.

As a result of this significant need for time and effort, the cost of producing CGI content can be cost prohibitive in many situations. For example, a large car manufacturer's marketing budget in one particular territory may be only $30,000 USD for content creation as to a number of different models of vehicle. Depending on the CGI content to be created, this budget and the cost of CGI content creation do not match, especially in a scenario where multiple daily social media posts need to be made in addition to TV, web and print advertising. All of these channels can require different quality, aspect ratio, image size and various other modifications, each requiring input or action from a CGI software specialist.

Furthermore, content produced by that specialist will often require revisions from an advertising/creative team, resulting in more CGI specialist time and expense with each revision.

The editable CGI files are often large and difficult to send via email because they include large files of three dimensional models with detailed design and color specs and surface information necessary to generate realistic images. This makes it difficult to share editing capabilities with the persons in marketing/creative that want to make edits to draft content.

Therefore, editing and manipulation is not in real time, particularly to the reviewer.

### SUMMARY OF THE INVENTION

Accordingly, there is a need for a CGI system that can utilize pre-configured CGI asset files to combine them in a way that is user friendly to produce high quality rendered CGI assets.

It is therefore an object of the invention to provide for CGI asset creation via a web based interface that is easy to use and operate.

It is another object to provide for CGI asset creation and modification that can be done by persons without specialized CGI software training.

It is another object to provide for CGI asset creation that allows for realistic CGI assets to be created and modified.

It is another object to allow for rendered assets based on CGI content to be easily modified by the creating user or another user.

It is yet another object to allow for CGI assets to be modified in real time and rendered via a web based user interface while also minimizing bandwidth required to allow three dimensional manipulation.

These and other objects are achieved by providing a CGI asset generation system with a web based user interface which receives selections and commands from a user to select a background an object, which commands are sent to a server, the server then uses a CGI program to generate an image file from those commands and displays with the perspective information of the background being used to modify how the object is displayed in the CGI asset by e.g. shading, lighting, shadow of the object and of the background as appropriate.

In one aspect a Computer Generated Imagery (CGI) system includes a processor having software executing thereon, said software providing a user interface which allows a user to select two or more asset files which are pre-configured CGI asset files to combine the two or more asset files into a CGI asset. A first asset is a background and is one of the two or more asset files, and a second asset is an object and is one of the two or more asset files. The first asset includes image content and perspective information which perspective information is indicative of: ground plane, surface information, point of view position, lighting or combinations thereof associated with the background. The software uses the perspective information to modify how image content of the second asset is displayed relative to the first asset on the user interface and the user interface allows the second asset to be user manipulated consistent with the perspective information to create the CGI asset.

In certain aspects the user interface allows the second asset to be user manipulated by moving a position of the second asset relative to the background such that a change in position of the second asset modifies an orientation of the second asset, lighting of the asset, shadow of the asset or combinations thereof. In other aspects, the first asset is a three dimensional background. In still other aspects, the user interface allows the perspective information to be user modifiable to modify how the background is displayed. In yet other aspects modification of the perspective information modifies how the second asset is displayed relative to the first asset. In still other aspects the three dimensional background and perspective information is used to modify how the second asset is displayed in order to provide a reflection of at least part of the background on the second asset. In yet other aspects the second asset can be user manipulated to change a color thereof. In yet other aspects the second asset can be user manipulated to change a configuration thereof. In still other aspects the second asset is a vehicle and the configuration defines: a vehicle feature, vehicle element position or combinations thereof. In still other aspects the user interface is displayed on a display which is remote to the processor via a network. In yet other aspects the CGI asset is downloadable as an image or video file containing state data such that the CGI asset, when opened at the user interface, is editable such that the second asset can be manipulated relative to the first asset from a starting point based on the CGI asset as opened. In yet other aspects the state data is indicative of at least: a position relative to the background, a configuration of the second asset or combinations thereof. In still other aspects the user interface allows for rendering of the CGI asset in a user specified quality, resolution, aspect ratio or combinations thereof. In still other aspects the state data is metadata. In still other aspects the user interface is a web based user interface and the processor includes a server. In still other aspects a second software executes on the processor or a second processor, and the second software is a CGI software which accesses a storage containing the at least two assets, at least one of said at least two assets is a three dimensional model and the CGI software manipulates the three dimensional model based on instructions from the software which are generated in response to user commands input via the user interface. In still other aspects the software receives commands via the user interface and converts those commands into commands for the CGI software such that the CGI software generates the CGI asset for display on the user interface based on the commands.

Other objects are achieved by providing a Computer Generated Imagery (CGI) system including a processor having software executing thereon, said software providing a user interface which is web based and which allows a user to select two or more asset files to combine into a CGI asset. A first asset is a three dimensional background model and is one of the two or more asset files, and a second asset is a three dimensional object model and is one of the two or more asset files. The first asset includes image content and perspective information which is indicative of: ground plane, surface information, point of view position, lighting or combinations thereof, wherein the user interface allows user modification of the perspective information to change how the background is displayed. The software uses the perspective information to modify how image content of the second asset is displayed relative to the first asset on the user interface and the user interface allows the second asset to be user manipulated to create the CGI asset.

In certain aspects the CGI asset is downloadable from the user interface in a file containing image data and metadata, the metadata including state information indicative of: the perspective information of the first asset, configuration information for the second asset or combinations thereof. In yet another aspect the file of the CGI asset can be opened from the user interface at any computing device that can display and manipulate the user interface to allow further modification of the CGI asset with a starting point of the CGI asset as downloaded from the user interface and opened at the any computing device. In still other aspects a second software executes on the processor or a second processor and the second software is a CGI software which accesses a storage containing the at least two assets, at least one of said at least two assets is a three dimensional model and the CGI software manipulates the three dimensional model based on instructions from the software which are generated in response to user commands input via the user interface.

Other objects are achieved by providing a Computer Generated Imagery (CGI) system including a processor having software executing thereon, said software providing a user interface which is web based and which allows a user to select two or more asset files to combine into a CGI asset. A first asset is a background and is one of the two or more asset files, and a second asset is a three dimensional object model and is one of the two or more asset files. The first asset includes image content and perspective information which is indicative of: ground plane, surface information, point of view position, lighting or combinations thereof. The software uses the perspective information to modify how image content of the second asset is displayed relative to the first asset on the user interface and the user interface allows the second asset to be user manipulated to create the CGI asset.

In certain aspects, a second software executes on the processor or a second processor and the second software is a CGI software which accesses a storage containing the at least two assets, at least one of said at least two assets is a three dimensional model and the CGI software manipulates the three dimensional model based on instructions from the software which are generated in response to user commands input via the user interface and manipulates how the three dimensional model is displayed on the background based on the perspective information such that shadow, lighting, positioning or combinations thereof is determined at least in part by the CGI software based on the perspective information. In still other aspects the second asset is a three dimensional background and the perspective information is user modifiable via controls on the user interface.

Other objects are achieved by providing a Computer Generated Imagery (CGI) system including a processor having software executing thereon, said software providing a user interface which is web based and which allows a user to select two or more asset files from a plurality of asset files to combine into a CGI asset. At least one of the asset files is a background model having image content and perspective information which perspective information is indicative of: ground plane, surface information, point of view position, lighting or combinations thereof. At least two of the asset files are a three dimensional object model, each of different objects. The user interface allows the user to select one background model and at least one three dimensional object model for combination in to the CGI asset, wherein the software presents image data to the user interface for display to the user and the software uses the perspective information to modify how image content of the three dimensional object model is displayed relative to the background model on the user interface such that the three dimensional object model is displayed consistent with the perspective information and the user interface allows the three dimensional object model to be user manipulated to create the CGI asset.

In certain aspects the user interface allows the three dimensional object model to be user manipulated by moving a position of the three dimensional object model relative to the background model such that a change in position of the three dimensional object model modifies an orientation of the three dimensional object model, lighting of the three dimensional object model, shadow of the three dimensional object model or combinations thereof. In other aspects the background model is a three dimensional background. In still other aspects the user interface allows the perspective information to be user modifiable to modify how the background is displayed. In yet other aspects modification of the perspective information modifies how the three dimensional object model asset is displayed relative to the background model.

Other objects of the invention and its particular features and advantages will become more apparent from consideration of the following drawings and accompanying detailed description.

### BRIEF DESCRIPTION OF THE DRAWINGS

FIG. 1 is a functional flow diagram according to the present invention

FIG. 2 represents a CGI asset generated by FIG. 1

FIG. 3 is a functional flow diagram according to certain features of the system of FIG. 1

FIG. 4 is a functional flow diagram according to certain features of the system of FIG. 1.

FIGS. 5-11 show various views of the user interface according to FIG. 1.

FIG. 12 shows an exemplary system architecture for the system of FIG. 1.

### DETAILED DESCRIPTION OF THE INVENTION

Referring now to the drawings, wherein like reference numerals designate corresponding structure throughout the views. The following examples are presented to further illustrate and explain the present invention and should not be taken as limiting in any regard.

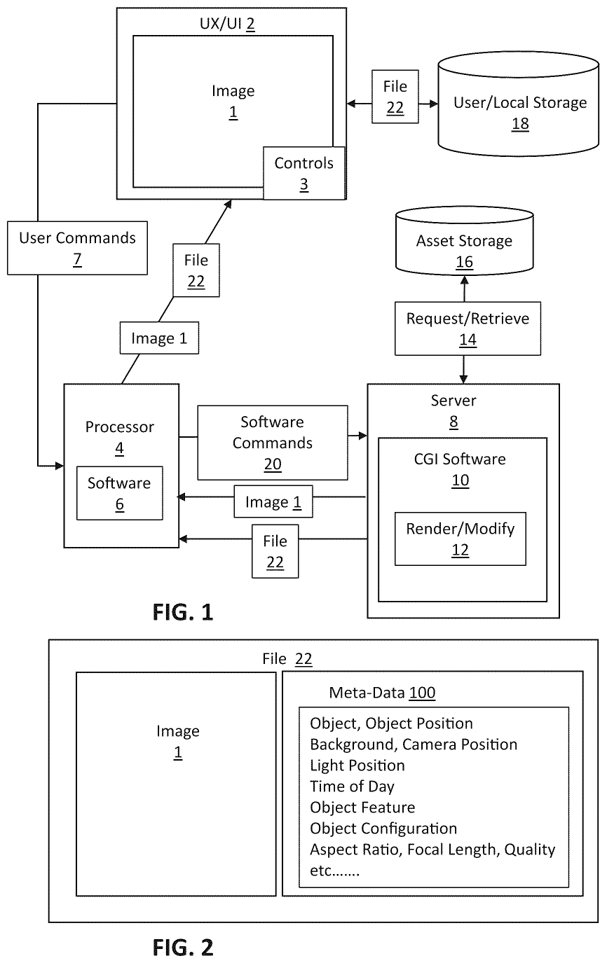

Referring to FIG. 1, the system provides a user interface 2 which can display the image 1 and provides controls 3 for manipulation. These controls come in the form of user commands which can allow the user to select a background, an object, a configuration, color, lighting and various elements to create a CGI image 1. Preferably the user interface 2 is web based and is provided through the user's browser. The commands 7 are transmitted to a processor 4 which executes software 6. That software interprets the commands 7 and generates software commands 20. The software commands 20 interpret the relatively simple user commands into instructions for the CGI software 10 which operates on a server 8. That server has assets to an asset storage library 16 which is how the user is able to select from various backgrounds/objects for generation of the image 1. These backgrounds and objects are pre-configured asset files which have one or more components of perspective information already embedded and/or programmed into that asset file.

Particularly, this perspective information for a background may include, for example, ground plane, surface information, point of view position and/or lighting. These pre-configured assets can then constrain how objects can be placed on them in a manner that the generated image 1 looks realistic. For example, if a background exists with a light source coming from the user's point of view, this information needs to be used in connection with objects placed on that background to make the image 1 consistent. Specifically, if the object were placed on the background and the shadow of that object went left to right but the background had a light source from the user's point of view, the shadows cast by the object would not be consistent with the background and the image 1 would not look realistic. Therefore, the perspective information of the background such a lighting, light position and camera position can all be used to show an object in the image 1 in a way that is consistent with that perspective information. Ground plane and surface information can also be used to appropriately position the object on the background in a manner consistent with the background. Particularly, if the object being placed on the background is a vehicle, that vehicle should appear to be resting on the ground surface at an angle that would be consistent with a real world configuration, or that option should easily be user selectable. Furthermore, the ground plane can determine where the shadows are cast relative to the object and the same holds true for other surfaces.

It is also understood that the light position and intensity can determine how the object is displayed and how shadows are cast. For example, in the case of a pickup truck, the position of the light and its intensity can determine how the truck bed casts shadows, even on itself in that the sides of the truck bed can cast a shadow on the base of the bed, depending on the light position.

While it is possible that the perspective information may be fixed in a 2d or fixed background, it is also contemplated that the perspective information may be user editable in some cases. In such a scenario, the background asset in the asset storage 16 would be a 3d model. In the example of a 3d asset, the camera position can change as can the light (e.g. time of day/clouds), light position and the position of the object which then determines what surface/ground planes apply. Thus, the perspective information can be user editable to allow the object to be shown in various locations within the 3d background.

It is also contemplated that the background may modify the appearance of the object, namely the object may be relatively reflective (such as car paint) and the nearby presence of e.g. rocks in the background may cause those rocks to show up in a reflection 250 on the door panel of the vehicle, thus the ability to display the reflection 250 causes the background's visual features to modify how the object appears. The configuration of the object can also be modified in that a color can be changed, doors opened/closed and various configurations/trims selected. The pre-configured asset in the asset storage 16 allows for selection of various trims or other pre-configured features of the vehicle.

As can be seen in FIG. 1, the software commands 20 are used by the CGI software to render/modify 12 the image 1 and file 22. Notably, the CGI software 10 on the server 8 allows for the large files in the asset storage 16 to be kept separately from the user interface. In this manner, the large processing power required to manipulate the pre-configured assets is local to the server 8 but then the web based interface 2 can receive the image 1 and/or file 22 the controls 3 are manipulated. The image 1 in the editing mode of the user interface 2 will typically be a stream of images in that the user will be manipulating the controls 3, causing user commands 7 and the resultant software commands 20. The Server 8 will respond with the image 1 in the form of a changing stream that depends what these commands 7 are. Thus, the image 1 as output from the server may actually be a real time video stream of the manipulations the CGI software 10 is implementing. Ultimately, the user may choose to download a file 22 in a rendered format which includes an image 1 which is fixed in terms of its content. This rendering may designate a particular quality, aspect ratio or other features.

As shown in FIG. 2, the file 22 has two key components. The first is the image 1, which may be a static image or a video stream configured according to the user manipulations, but which cannot be further modified outside the user interface 2. The meta-data 100 acts as state data for the CGI asset. Particularly, the Meta-data can be a set of codes or instructions indicative of the background, camera position, object, object position, light position, time of day, object feature, object configuration, aspect ratio, focal length, quality and other data indicating how the background and object are configured in the manner that is represented by the already defined image 1. As can be seen in FIG. 1, the file 22 can be downloaded from the user interface 2 to user storage 18. The file 22 can also be shared such as via email, messaging, file transfer or others. Since the file 22 as shared will include the meta data 100, this meta data 100 can act as user commands 7 when the file is re-opened in the user interface. The file 22 can be re-opened by the same user or a different user and the meta data 100 will essentially provide the set of user commands 7 necessary to have the image 1 be in the fixed state as provided in the file but now be editable from the controls 3 so that the CGI software 10 will again be live streaming in real or near real time the manipulations to the assets the user is putting into the controls 3. Thus, when the file 22 is re-opened/uploaded in the user interface 2, that file and the image 1 becomes editable with the image 1 in the file 22 as the starting point.

Such a feature is important for the review/commenting process. Particularly, if after review, the decision is made to change the color of the object, this can be done very quickly in that the file is opened with the user interface 2, the meta data is read by the software 6 and the image 1 can now be edited to easily change the color without the need to re-start from scratch by selecting the object and background features. Importantly, this is all done in a manner that the file 22 is a fixed rendered file that does not contain three dimensional data but which once uploaded to the user interface 2, the image 1 and the features thereof become editable in three dimensions. Thus, the file 22 is relatively small in size in comparison to the assets necessary to create that file. The meta-data 100 typically is just text information and then the image 1 portion of that file is the rendered image/video. While the image may be relatively large in file size compared to just text, it is still significantly smaller than the three dimensional models used to create the image.

Therefore, by separating the 3d processing to be on the server 8 and the controls 3 to be provided web based, the image display/streaming is then transmitted over the network (between server 8 and processor 4). Then, the web based user interface 2 is displaying what looks to be a 3d model being manipulated but is really displaying an image stream. As a result, the bandwidth necessary to display the image 1 on the user interface is significantly reduced, even though the controls 3 and commands 7 for manipulation of the 3d model are input remote to the CGI software 10. Particularly, the commands 7 may be input remote via a public network (e.g. web) and a private network (e.g. between the processor 4 and server 8).

The file 22 can also be read by any imaging program that can accept its file type e.g. jpg, png, tiff, mov, mpeg4 or other image/video file types and the meta-data is only displayed if the user seeks to display that information. Otherwise, the file 22 and the image 1 therein can be printed or otherwise used in various print, online and other media forms. Thus, the file 22 is of a common image/video file type with added meta-data so that the file 22 can be read/printed by commercially available software/printers and can also be added to the user interface 2 to allow for real time or near real time editing of the three dimensional object(s) represented in the image 1.

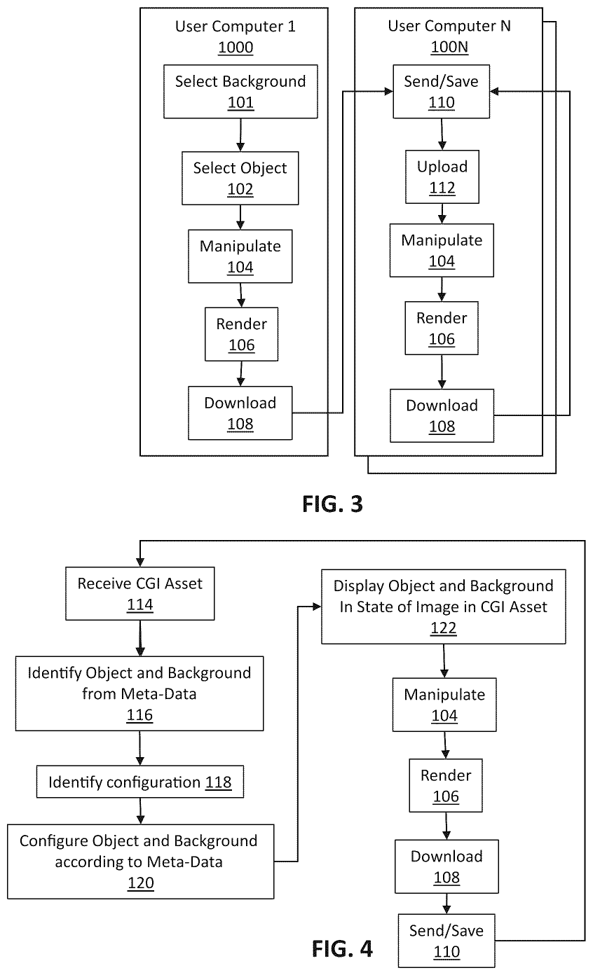

FIG. 3 shows an example process whereby one user can create the initial draft CGI asset render and another user (or the same user) can then change that draft. As shown, user computer 1000 displays the web interface 2 and the user can select a background 101 and an object 102 and then manipulate 104 that object and render the image 106 to allow for download 108 of the file 22. Here, the file 22 will have meta-data 100 that indicates what background was selected, what object was selected, how those were manipulated and rendered, typically in text form. User computer N 100N (which may be computer 1000 or another computer) goes through a similar process, but instead of starting from nothing, the file 22 is uploaded 112 to the user interface 2. This upload 112 reads the meta data and automatically selects the background/objects and manipulations that are represented by the image 1 in the file 22 so that user computer 100N displays that image 1, but in editable format such that the three dimensional object/background manipulation 104 can continue from where the last user (or the same user) left off with regards to the file that was sent/saved 110 before being re-uploaded to the user interface 2. That now changed file 22 can be downloaded 108 again and sent/saved 110 as needed for further review/editing or for publication/use. Preferably the metadata will stay with the file 22 such that if the file 22 is rendered in a way appropriate for e.g. social media use (appropriate size/quality/aspect ratio), the file can be uploaded 112 to the user interface 2 at a later time and the user can select a different quality, e.g. for large format printing or otherwise.

Thus, the image file 22 itself includes instructions for how the various backgrounds/objects are configured in the image such that real time editing can re-commence simply upon adding the image file to the user interface 2.

FIG. 4 shows further detail of the process of utilizing the meta-data. The CGI asset is received 114, typically at the user interface 2. The meta data is used by the processor 4 and its software 6 to identify the object and background from that meta data 116. The meta data will also have state information about the configuration 118, allowing commands 20 to be sent to the CGI software 10 to configure the object and background 120 and the various perspective and object position/configuration information to match the meta-data. The user interface then displays the object and background according to the meta-data 122 in now real or near-real time editable form. Here, image 1 displayed on the user interface now becomes an image stream that is sent from the CGI software 10 to the software tool 6. Thus, the 3d modification of the background/object is done at the server 8 side whereas the user interface 2 is displaying what is an image/video stream made by the CGI program 10. As a result, the bandwidth/processing power to display the image 1 at the user interface 2 is similar or comparable to video streaming, but the stream is essentially user editable in high quality in real time.

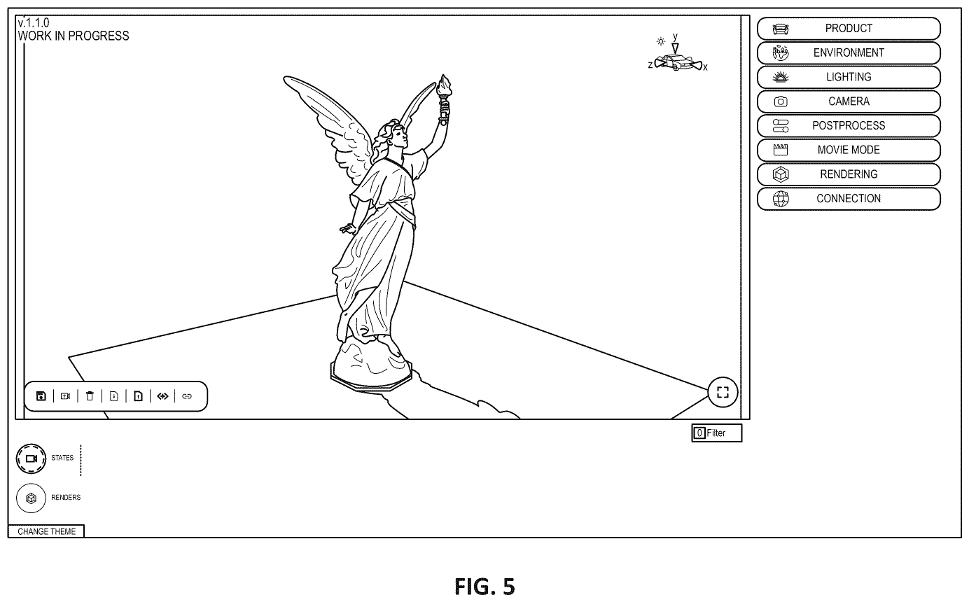

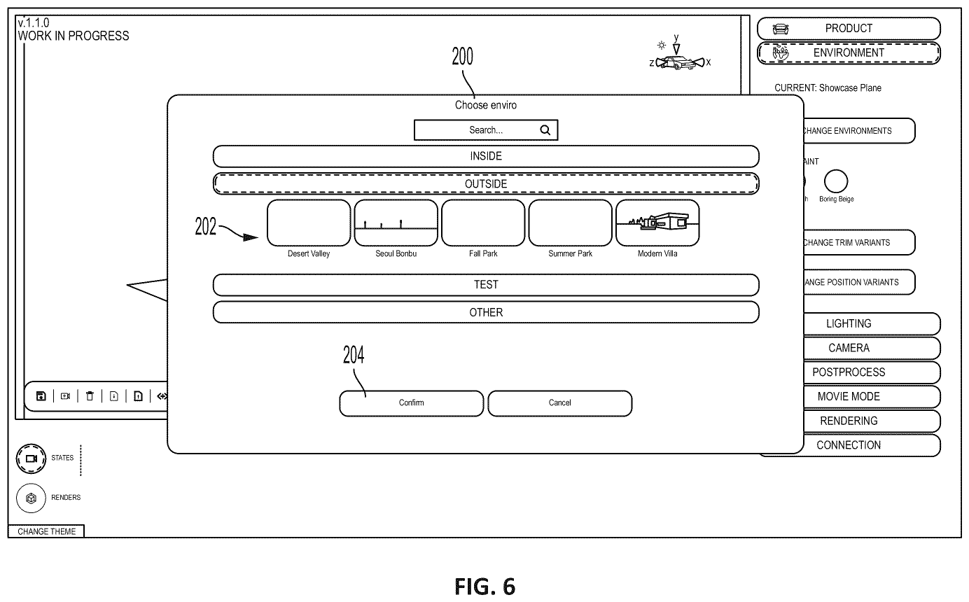

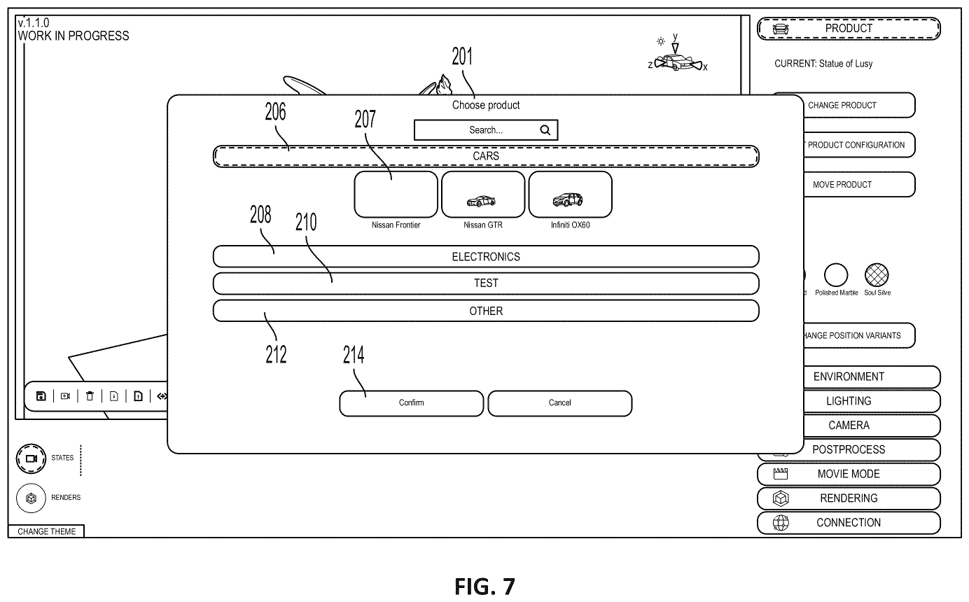

Referring to FIGS. 5-11, features of the user interface 2 are shown. FIG. 5 shows an example starting point where no background or object has been selected and a placeholder is found. FIG. 6 shows how an environment (background) 200 is selected from a number of available options 2002. These options may be divided into different categories such as inside and outside and various other sub-categories. The user confirms 204 the selection of the background 202 and it is loaded to the user interface. Next, the user can select the product (object) 201 to be placed in the environment 200. As can be seen, a number of categories 206, 208, 210, 212 are provided and within that category, a number of options are available. The user can select an option 207 and confirm 214 to have that product display on the selected background.

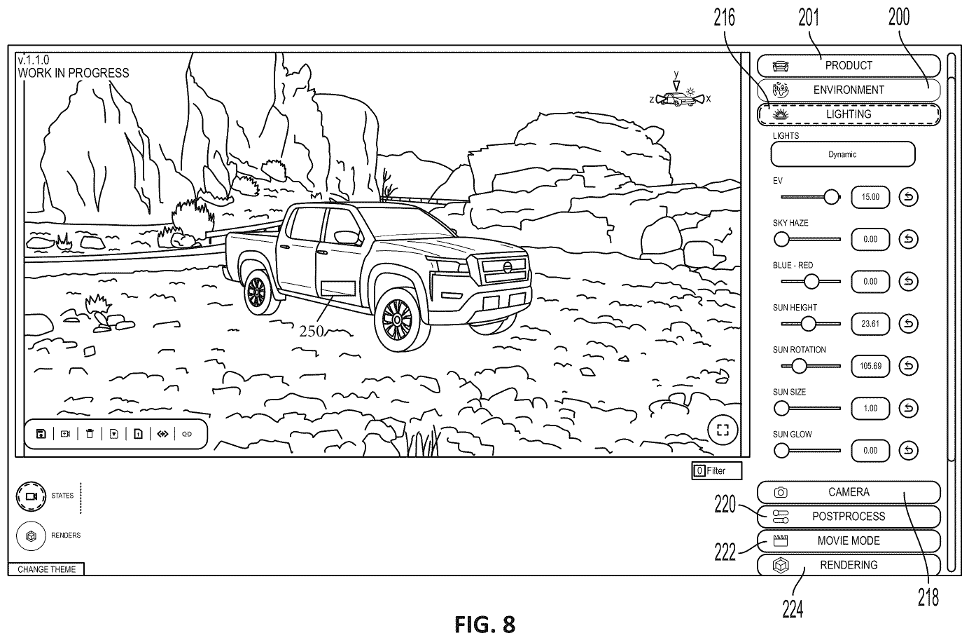

FIG. 8 shows an example where the product 201 and environment 200 have been selected and the user is now provided an option to change the lighting 216. When the user makes that selection, a number of lighting options are available including sun position, size, and various light configurations/contrasts. As the user slides the bars shown, the lighting changes as do the shadows cast. The example shown is a 3d background. If a 2d background is selected, the lighting 216 option may not be available and instead the parameters shown as user configurable in FIG. 8 are instead hard coded into the background asset. Also shown are camera 218, post processing 220, movie mode 222 and rendering 224 options. The camera 218 option can be used to change the camera lens, focal length, etc that is taking the photo as if the actual camera changed, but without needing to re-shoot the image. Post processing allows for various effects and filters to be applied. Movie mode 222 can allow for various animation features such that the output is a movie file rather than an image. Rendering 224 allows for the output file 22 to be provided in various sizes, qualities, aspect ratios and other selections as needed to be useable in various print, web and mobile environments.

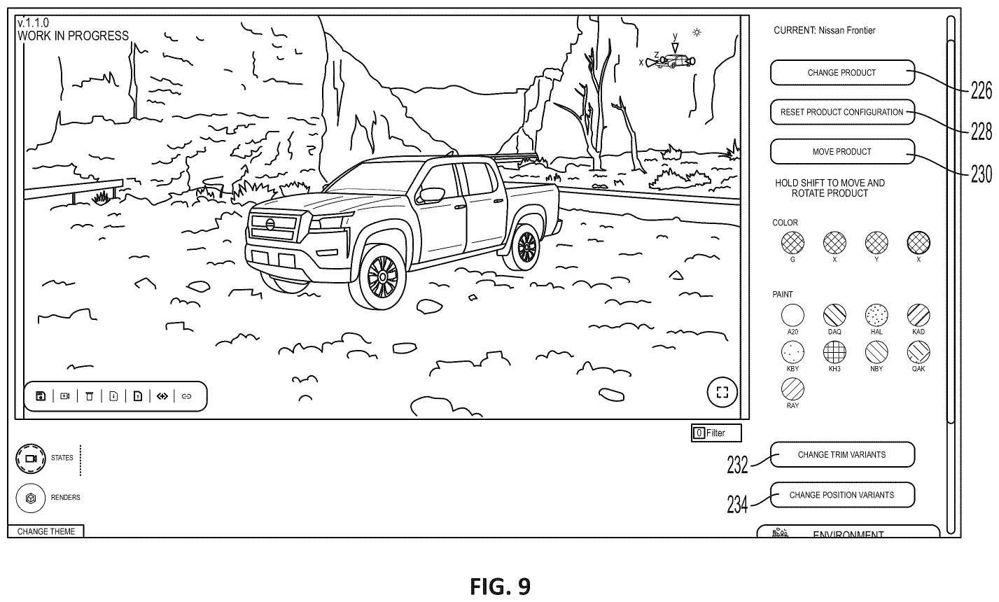

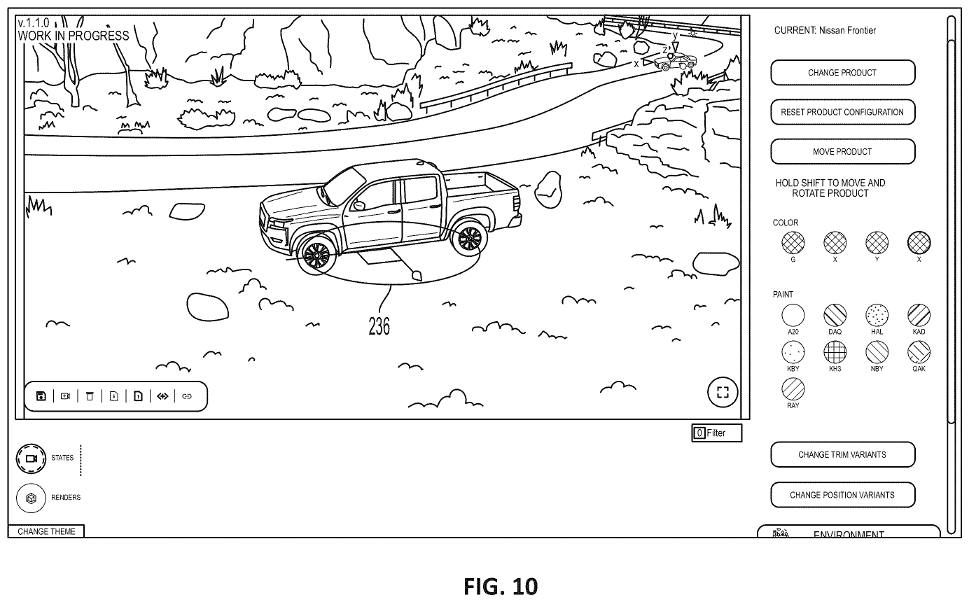

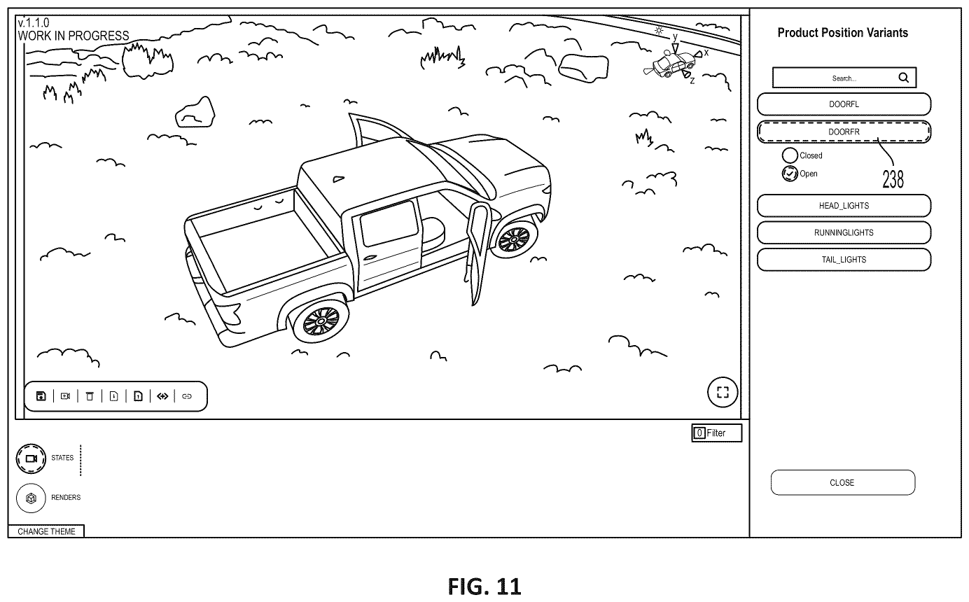

FIG. 9 shows options within the product menu. The user can change the product 226, reset the configuration 228 and move the product 230. Changing the product would e.g. change the model of car, resetting the configuration 228 would go back to the default arrangement. Moving the product 230 allows the user to change the position of the car (See FIG. 10). The trim can also be changed 232 to different wheels or fairings or other structural elements of the product. As shown, the color option has been selected and the various default paint colors are user selectable or customizable. The position variants 234 can also be changed (See FIG. 11).

FIG. 10 shows what happens when the “move product” option is selected. An orientation plane 236 is displayed at the product and allows the user to drag to move the car. Preferably, the plane is locked relative to the defined ground plane/surface the car is on so that the car when moved is in the correct position relative to the ground/surface.

FIG. 11 shows various options available for changing how features of the product are displayed. In this case, the rear front door is selected to be opened, but closed would close that door. The head lights, running lights, tail lights can be on/off in various combinations and within the head lights option, a high beams option can be selected. Other configuration options can be provided, depending on the product, however these options are pre-configured in the 3d model of the asset that is manipulated by the CGI software 10. For example, opening the hood to display the engine, dropping the truck bed, opening the trunk, opening windows. All of these manipulations would be pre-configured in the 3d asset file the CGI software 10 uses to provide the image 1 stream to the user interface.

As described previously, the present system allows for download/saving/sharing of the file 22 which is a rendered image asset, this may be a still image or a video image. The quality and size of the image available is user selectable and also sufficient for use in marketing and publication. For example, sizes such as 4k, 8k, 10k are available and these are provided as a clean image without controls/features of the user interface displayed on them unless user selected to do so.

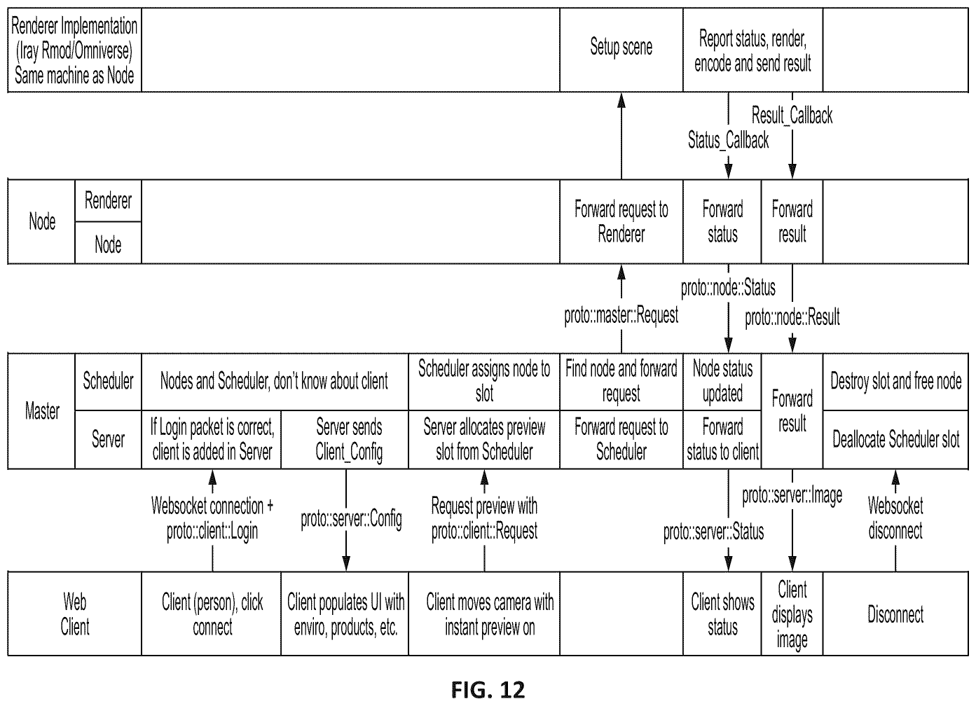

FIG. 12 shows the system architecture with the bottom row representing the web client, the master representing the main server which can have various nodes that are assigned to various processing tasks and then the renderer implementation includes CGI software that executes on the node. As can be seen, the web client which presents the user interface allows the user (client) to click to connect. The master determines if the login packet is correct and then the master (server) sends the client configuration to the web client. The UI is populated with the available environments (backgrounds) and products (objects) for selection/manipulation. At this stage, the nodes and scheduler have not been tasked with implementing any CGI commands to combine the images, so the nodes and scheduler are not aware of this interaction. The client then chooses the background and object for display which results in a preview request for combining these assets. The client may also move the camera position in the case of a 3d model. The master server then allocates the preview from the scheduler which job is then assigned to a node. The request to preview is forwarded to the node which has the renderer setup the scene. The renderer sends back the status, the render and encodes and sends the result. These are forwarded through the node to the server which then allows the web interface to show the status and image. The process repeats as the user manipulates the position of the object on the background or moving the camera or otherwise modifying various features described previously. The preview request from the web client will come to the master in a way that is different than what information the renderer needs to complete the request, thus the master server and its software will interpret the preview request and transform it into a master request suitable for providing necessary instructions to the renderer to complete the preview request. With the image displayed, the user can download the image such that the image includes the meta data 100 the status may be contained in the meta data. In this case, the step of the client (user) populating the UI with the environment and products would involve selecting the previously generated and downloaded image with this meta data. The meta data is read by the UI or the master and is considered a request for a preview such that the image now can be manipulated from the point where the last user who downloaded the file left off, i.e. using the last status of the image as the starting point. In this way, the image can again be manipulated by the user, but from the starting point of the last status.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A Computer Generated Imagery (CGI) system comprising:
a processor having software executing thereon, said software providing a user interface which allows a user to select two or more asset files which are pre-configured CGI asset files to combine the two or more asset files into a CGI asset;
a first asset is a background and is one of the two or more asset files, and a second asset is an object and is one of the two or more asset files;
the first asset includes image content and perspective information which perspective information is indicative of: ground plane, surface information, point of view position, lighting or combinations thereof associated with the background;
wherein the software uses the perspective information to modify how image content of the second asset is displayed relative to the first asset on the user interface and the user interface allows the second asset to be user manipulated consistent with the perspective information to create the CGI asset.

2. The system of claim 1 wherein: the user interface allows the second asset to be user manipulated by moving a position of the second asset relative to the background such that a change in position of the second asset modifies an orientation of the second asset, lighting of the asset, shadow of the asset or combinations thereof.

3. The system of claim 1 wherein the first asset is a three dimensional background.

4. The system of claim 3 wherein the user interface allows the perspective information to be user modifiable to modify how the background is displayed.

5. The system of claim 4 wherein modification of the perspective information modifies how the second asset is displayed relative to the first asset.

6. The system of claim 3 wherein the three dimensional background and perspective information is used to modify how the second asset is displayed in order to provide a reflection of at least part of the background on the second asset.

7. The system of claim 1 wherein the second asset can be user manipulated to change a color thereof.

8. The system of claim 1 wherein the second asset can be user manipulated to change a configuration thereof.

9. The system of claim 8 wherein the second asset is a vehicle and the configuration defines: a vehicle feature, vehicle element position or combinations thereof.

10. The system of claim 1 wherein the user interface is displayed on a display which is remote to the processor via a network.

11. The system of claim 1 wherein the CGI asset is downloadable as an image or video file containing state data such that the CGI asset, when opened at the user interface, is editable such that the second asset can be manipulated relative to the first asset from a starting point based on the CGI asset as opened.

12. The system of claim 1 wherein the state data is indicative of at least: a position relative to the background, a configuration of the second asset or combinations thereof.

13. The system of claim 1 wherein the user interface allows for rendering of the CGI asset in a user specified quality, resolution, aspect ratio or combinations thereof.

14. The system of claim 10 wherein the state data is metadata.

15. The system of claim 1 wherein the user interface is a web based user interface and the processor includes a server.

16. The system of claim 1 further comprising a second software executing on the processor or a second processor, wherein the second software is a CGI software which accesses a storage containing the at least two assets, at least one of said at least two assets is a three dimensional model and the CGI software manipulates the three dimensional model based on instructions from the software which are generated in response to user commands input via the user interface.

17. The system of claim 1 wherein the software receives commands via the user interface and converts those commands into commands for the CGI software such that the CGI software generates the CGI asset for display on the user interface based on the commands.

18. A Computer Generated Imagery (CGI) system comprising:
a processor having software executing thereon, said software providing a user interface which is web based and which allows a user to select two or more asset files to combine into a CGI asset;
a first asset is a three dimensional background model and is one of the two or more asset files, and a second asset is a three dimensional object model and is one of the two or more asset files;
the first asset includes image content and perspective information which is indicative of: ground plane, surface information, point of view position, lighting or combinations thereof, wherein the user interface allows user modification of the perspective information to change how the background is displayed;
wherein the software uses the perspective information to modify how image content of the second asset is displayed relative to the first asset on the user interface and the user interface allows the second asset to be user manipulated to create the CGI asset.

19. The system of claim 18 wherein the CGI asset is downloadable from the user interface in a file containing image data and metadata, the metadata including state information indicative of: the perspective information of the first asset, configuration information for the second asset or combinations thereof.

20. The system of claim 19 wherein the file of the CGI asset can be opened from the user interface at any computing device that can display and manipulate the user interface to allow further modification of the CGI asset with a starting point of the CGI asset as downloaded from the user interface and opened at the any computing device.

21. The system of claim 1 further comprising a second software executing on the processor or a second processor, wherein the second software is a CGI software which accesses a storage containing the at least two assets, at least one of said at least two assets is a three dimensional model and the CGI software manipulates the three dimensional model based on instructions from the software which are generated in response to user commands input via the user interface.

22. A Computer Generated Imagery (CGI) system comprising:
a processor having software executing thereon, said software providing a user interface which is web based and which allows a user to select two or more asset files to combine into a CGI asset;
a first asset is a background and is one of the two or more asset files, and a second asset is a three dimensional object model and is one of the two or more asset files;
the first asset includes image content and perspective information which is indicative of: ground plane, surface information, point of view position, lighting or combinations thereof;
wherein the software uses the perspective information to modify how image content of the second asset is displayed relative to the first asset on the user interface and the user interface allows the second asset to be user manipulated to create the CGI asset.

23. The system of claim 22 further comprising a second software executing on the processor or a second processor, wherein the second software is a CGI software which accesses a storage containing the at least two assets, at least one of said at least two assets is a three dimensional model and the CGI software manipulates the three dimensional model based on instructions from the software which are generated in response to user commands input via the user interface and manipulates how the three dimensional model is displayed on the background based on the perspective information such that shadow, lighting, positioning or combinations thereof is determined at least in part by the CGI software based on the perspective information.

24. The system of claim 23 wherein the second asset is a three dimensional background and the perspective information is user modifiable via controls on the user interface.

25. A Computer Generated Imagery (CGI) system comprising:
a processor having software executing thereon, said software providing a user interface which is web based and which allows a user to select two or more asset files from a plurality of asset files to combine into a CGI asset;
at least one of the asset files is a background model having image content and perspective information which perspective information is indicative of: ground plane, surface information, point of view position, lighting or combinations thereof and
at least two of the asset files are a three dimensional object model, each of different objects;
the user interface allows the user to select one background model and at least one three dimensional object model for combination in to the CGI asset, wherein the software presents image data to the user interface for display to the user and the software uses the perspective information to modify how image content of the three dimensional object model is displayed relative to the background model on the user interface such that the three dimensional object model is displayed consistent with the perspective information and the user interface allows the three dimensional object model to be user manipulated to create the CGI asset.

26. The system of claim 25 wherein: the user interface allows the three dimensional object model to be user manipulated by moving a position of the three dimensional object model relative to the background model such that a change in position of the three dimensional object model modifies an orientation of the three dimensional object model, lighting of the three dimensional object model, shadow of the three dimensional object model or combinations thereof.

27. The system of claim 25 wherein the background model is a three dimensional background.

28. The system of claim 27 wherein the user interface allows the perspective information to be user modifiable to modify how the background is displayed.

29. The system of claim 28 wherein modification of the perspective information modifies how the three dimensional object model asset is displayed relative to the background model.
